(19) United States
(12) Patent Application Publication
(10) Pub. No.: US 2008/0208788 A1
(43) Pub. Date: Aug. 28, 2008

(54) METHOD AND SYSTEM FOR PREDICTING CUSTOMER WALLETS

(75) Inventors: Srujana Merugu, Sunnyvale, CA (US); Claudia Perlich, Mount Kisco, NY (US); Saharon Rosset, Mount Kisco, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: INTERNATIONAL BUSINESS MACHINES CORPORATION, Armonk, NY (US)

(21) Appl. No.: 11/679,430

(22) Filed: Feb. 27, 2007

(51) Int. Cl. G06N 7/00; G06F 17/30

(52) U.S. Cl. 706/53; 705/10

(57) ABSTRACT

A method (and system) of predicting an unobserved target variable includes building a graphical predictive model from domain knowledge, which takes advantage of conditional independence to facilitate inference about the unobserved target variable, given observations of other variables in the graphical predictive model from a plurality of information sources.

### BACKGROUND OF THE INVENTION

1. Field of the Invention

The present invention generally relates to a method and apparatus for generating predictive models, and more particularly to a method and apparatus for building a predictive model for an unobserved target variable.

2. Description of the Related Art

Customer “wallets” and “wallet shares” are critical quantities in planning marketing efforts, allocating resources, evaluating the success of different marketing channels, etc. A customer “wallet” is defined as the quantity that the customer has allocated to spend on a specific product category. It is important for a manufacturer to determine the value of the customer wallet for his customers.

Conventional solutions for determining (e.g., estimating) customer wallets rely on one or more existing techniques.

Specifically, certain conventional solutions rely on obtaining a sample of true customer wallets through a survey. This technique, however, is both expensive and unreliable.

Other conventional techniques start with high level aggregations and then dividing such aggregations among customers. This technique, however, is very unreliable at an individual customer level, because it depends on macro-economic models with strong assumptions.

Predictive modeling may also be used for estimating a value of a customer wallet. In standard predictive modeling methodology, an observed target variable of interest is modeled as a function of a collection of predictors. However, conventional techniques have not been designed for generating a predictive model for a target variable that is not observed. That is, there exists a need for predicting a target variable in cases where one can only observe the predictors, and never observe the target variable (when building a model or when using it to predict).

### SUMMARY OF THE INVENTION

In view of the foregoing and other exemplary problems, drawbacks, and disadvantages of the conventional methods and structures, an exemplary feature of the present invention is to provide a method and structure in which a value of an unobserved target variable is modeled without ever observing the unobserved target variable.

In accordance with a first exemplary aspect of the present invention, a method of predicting an unobserved target variable includes building a graphical predictive model from domain knowledge, which takes advantage of conditional independence to facilitate inference about the unobserved target variable, given observations on other variables in the graphical predictive model from a plurality of information sources.

In accordance with a second exemplary aspect of the present invention, a system for predicting an unobserved target variable includes a prediction unit that builds a predictive model from domain knowledge, which provides information about the unobserved target variable.

In accordance with a third exemplary aspect of the present invention, a system for predicting an unobserved target variable includes means for estimating a parameter that corresponds to a maximum incomplete discriminative likelihood of the domain knowledge, and means for estimating the target variable using an maximum incomplete discriminative likelihood solution of the domain knowledge.

In accordance with a fourth exemplary embodiment of the present invention, a computer-readable medium tangibly embodies a program of computer-readable instructions executable by a digital processing apparatus to perform a method predicting an unobserved target variable including building a graphical predictive model from domain knowledge, which takes advantage of conditional independence to facilitate inference about the unobserved target variable.

In accordance with a fifth exemplary aspect of the present invention, a method of deploying computer infrastructure, includes integrating computer-readable code in a computing system, wherein the computer readable code in combination with the computing system is capable of performing a method predicting an unobserved target variable including building a graphical predictive model from domain knowledge, which takes advantage of conditional independence to facilitate inference about the unobserved target variable.

Thus, the method and system of the present invention formalizes a maximum likelihood estimation problem of an unsupervised (unobserved) multi-view learning setting where the target is unobserved, but two independent parametric models can be formulated. In the case of Gaussian noise, the parameter estimation task can be reduced to a single linear regression problem. Thus, for the specific setting, the unsupervised multi-view problem can be solved via a simple supervised learning approach.

Accordingly, the method and system of the present invention can be applied to problems that model a numeric response that is never observed, but where there are two different, statistically independent, ways of modeling the unobserved response.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates a Bayesian network of an exemplary purchase model;

FIG. 2 depicts a flow diagram illustrating a prediction method 200 in accordance with an exemplary embodiment of the present invention;

FIG. 3 depicts a block diagram illustrating a prediction system 300 in accordance with an exemplary embodiment of the present invention;

FIG. 4 illustrates an exemplary hardware/information handling system 400 for incorporating the present invention therein; and

FIG. 5 illustrates a signal bearing medium 500 (e.g., storage medium) for storing steps of a program of a method according to the present invention.

### DETAILED DESCRIPTION OF EXEMPLARY EMBODIMENTS OF THE INVENTION

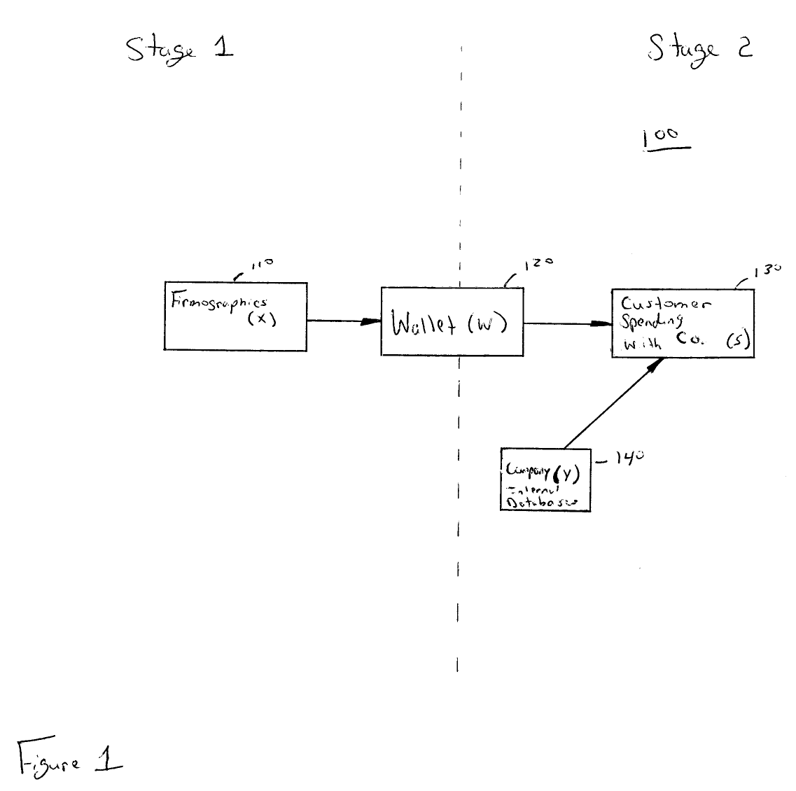

Referring now to the drawings, and more particularly to FIGS. 1-5, there are shown exemplary embodiments of the method and structures according to the present invention.

As previously discussed, certain exemplary aspects of the present invention are related to a method (and system) for predicting an unobserved target variable. For purposes of the present exemplary discussion, the present invention will be described with regard to a purchase model wherein a company is attempting to estimate the value of a customer wallet. However, the present invention is not limited to this specific application, which is merely provided for exemplary purposes for describing the present invention.

One definition of a customer wallet for a specific product category (e.g., information technology (IT)) is the customer's total budget for purchases in the product category across various venders. As an IT vendor, the company observes the amount its customers (which are almost invariably other companies) spend with it, but does not typically have access to the customers' budget allocation decisions, their spending with competitors, etc.

As indicated above, the desired target (e.g., the customer wallet) is completely unobserved. However, the company has access to two related information sources. The company has access to its internal databases, which tell the company about its relationship with the customer, including the current and past sales by product. Additionally, the company has access to publicly available firmographics about the customer company, including its revenue, industry, location, etc.

FIG. 1 further describes the above IT purchase process 100. The process involves two stages. In the first stage, the customer's executives decide on the customer's IT wallet 120 based on the customer's situation and needs, which are captured by firmographics 110. In the second stage, the IT department of the customer decides on the portion 130 of the wallet that is spent on the company's products depending on their relationship with the company, reflected in its internal databases 140.

The causal relations emerging from this purchase model can be readily represented in the form of a Bayesian network as illustrated in FIG. 1, wherein the firmographics (X) 110, the customer spending (S) 130 and the company's history (Y) 140 are conditionally independent of each other given the customers' wallet (W) 120.

Additional domain knowledge can then be used to identify the appropriate parametric forms for each of the causal relations in the Bayesian network. Given all of these, the unobserved wallet 120 can be treated as missing data and estimated via a maximum likelihood approach, e.g., using the Expectation-Minimization (EM) algorithm. A similar picture can be argued to apply for other business and scientific problems, e.g., estimating an online advertiser's share of customers' clicks, where the click behavior is unobserved, but some customer characteristics affecting it are known.

Certain aspects of the present invention are directed to a special case of two views and linear models with Gaussian noise. The present invention provides a solution to this problem by reducing it to a supervised learning problem that involves fitting the surrogate response (corresponding to the customer spending (S)) on the observed predictors. In addition to being computationally favorable, this method allows a user to harness the inferential power of linear modeling, including variable selection and analysis of variance (ANOVA)-based hypothesis testing, which can be used to test the validity of the conditional independence assumptions.

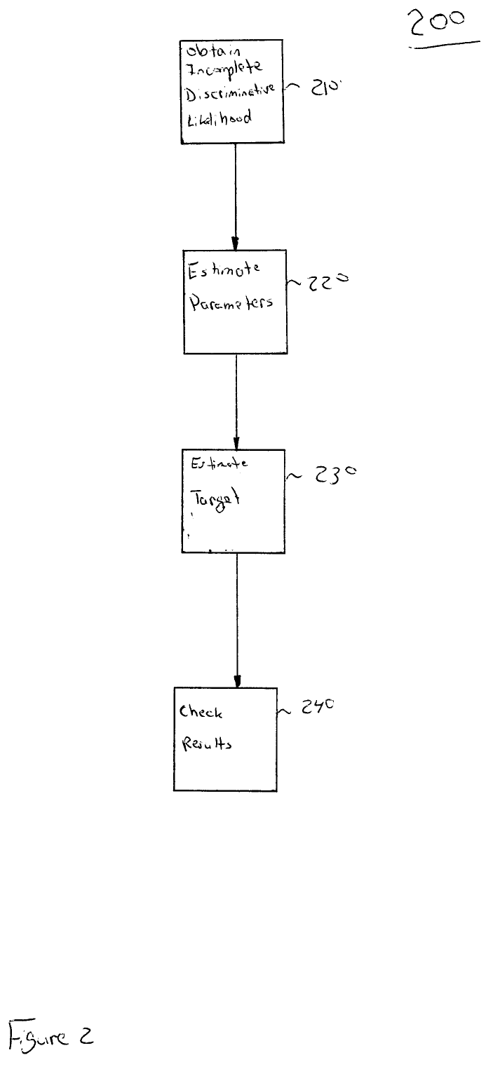

FIG. 2 illustrates a prediction method 200 in accordance with an exemplary embodiment of the present invention. Generally, the method 200 includes obtaining an incomplete discriminative likelihood 210, estimating parameters 220, obtaining the target variable 230 and then checking the obtained results 240. The specific method of the present invention is further described below.

The method 200 is used for predicting the unobserved target 120 (e.g., wallet (W)) given the predictors 110, 140. When the wallet (W)120 is observed, i.e., when there is access to training data on the wallet (W), domain knowledge can be used to specify a parametric form for the conditional distribution of the wallet (W) given all the predictors and estimate the parameters that maximize the discriminative likelihood p(W|X,Y,S). This is a standard modeling problem and is not the domain of the present invention.

In the absence of training data on the wallet (W) (as is usually the case, since it is not possible to observe W), one can still specify the parametric forms for the various conditional distributions using the causality information. However, the discriminative likelihood p(W|X,Y,S) cannot be computed. The best one can do is to predict the target 120 (e.g., wallet (W)) using the parameter estimates that are most consistent with the observed data (e.g., the firmographics (X) and the company history (Y)) as well as the Bayesian network assumptions.

A natural way to quantify this consistency is in terms of the incomplete data likelihood (i.e., the likelihood of the observed predictors). Since the main objective is to estimate only the unobserved target 120, one needs to only consider the incomplete discriminative likelihood corresponding to the surrogate response S or multiple surrogate responses (i.e., those that are influenced by the target).

The learning approach, therefore, includes two steps. A first step includes estimating the parameters that correspond to the maximum incomplete discriminative likelihood (220). A second step includes estimating the target using the parametric form of the conditional distribution p(W|X,Y,S) and the maximum likelihood estimates (230).

To obtain the incomplete discriminative likelihood, one first lets D be a dataset including n independent and identically distributed (n i.i.d.) tuples of the observed variables (X,S,Y) with W being unobserved. The joint likelihood of the data modeled by the Bayesian network can be readily obtained as follows:

P(W|M)=p_{D}(X)p_{D}(W|X)p_{D}(Y)p_{D}(S|W,Y)

Since S is a surrogate response, the incomplete discriminative likelihood corresponds to a conditional distribution p(S|X,Y). Therefore, assuming that p(W|X) follows the parametric form p_{θ0}(W|X) and letting p(S|W,Y) follow the parametric form p_{θ}(S|W,Y), the incomplete discriminative log-likelihood becomes:

L_{D}(⊖)=log(p_{D,⊖}(S|X,Y))=log(∫_{W}p_{D,θ}_{₀}(W|X)p_{D,θ}(S|W,Y))

where Θ=(θ₀,θ) and D in the sub-script denotes that the likelihood is evaluated on the dataset D.

Thus, the unsupervised learning problem, therefore, reduces to the optimization problem:

$${max}_{⊖} {L}_{D} ( ⊖ ) .$$

The resulting maximum likelihood estimates Θ* can now be plugged into the conditional distribution of the target given all the predictors to obtain p_{⊖*}(W|M)

In particular, the case where the conditional distributions p (W/X) and P(S/W,Y) are Gaussian is considered. Then, the method assumes the dataset D has n points and:

wᵢ−α^{t}xᵢ=ε_{w},ε_{w}˜N(0,σ_{w}²),[i]₁ⁿ (Eq. 1).

sᵢ−wᵢ−β^{t}yᵢ=εₛ,εₛ˜N(0,σₛ²),[i]₁ⁿ (Eq. 2).

Putting together these two equations one now formulates the maximum likelihood problem and solves it (e.g., using the EM algorithm) to obtain the maximum likelihood estimates α_{MLE}, β_{MLE}.

Additionally, the unobserved target variable 120 (W) can be eliminated from these two equations by adding them up, to get a simple linear regression problem:

sᵢ−γ^{t}zᵢ=ε_{ws},ε_{ws}˜N(0,σ_{ws}²),[i]₁ⁿ, (Eq. 3)

where the error ε_{ws} is the sum of the two independent errors ε_{w} and εₛ so that σ_{ws}²=σₛ²+σ_{w}², and Z=[X,Y] is the combined vector of predictors.

Next, one sets α_{LS}, β_{LS} to be the least squares estimators for the linear regression model in (Eq. 3). Then, the estimators α_{LS}, β_{LS} are identical to α_{MLE}, β_{MLE} when Z=[X,Y] is a full column rank matrix. If Z is not a full column rank matrix, the optimal parameter estimates for the linear regression model are not unique, but they are still identical to the optimal estimates of the maximum likelihood problem.

The results from the above theorem imply that the estimates α_{LS}, β_{LS} are consistent and that the resulting wallet estimates wᵢ* are unbiased. The above theorem illustrates that one can solve the problem of estimating the unobserved target 120 via a supervised learning approach on the surrogate target. This is of course beneficial from a computational perspective, as it allows harnessing the full power of linear regression methodology. This allows the user to use variable selection methodologies, such as forward and backward selection, and analysis of variance (ANOVA) for testing the quality of fit for nested models.

The use of ANOVA allows a user to test the conditional independence implied by the graphical model (e.g., 240). As indicated above, the predictor matrix Z is defined as a concatenation of the columns of X and Y. If a user wanted to extend the predictor matrix as Z′=[X², Y²] where the user uses X² to denote a matrix of size n×m₁² containing of all interactions between variables in X, and similarly for Y², then such a model would be completely consistent with both the linear model assumption and the graphical model in FIG. 1. It would just be a more elaborate model, and an ANOVA would determine whether it is supported by the data.

If, however, a user also wanted to add interactions between variables in X and variables in Y, then it would be a violation of the conditional independence assumption inherent in FIG. 1, since it defies the additive representation in Equations 1 and 2. Thus, if an ANOVA would tell the user that a model with interactions between variable in X and Y is superior, then that would cast a severe doubt on the independence assumptions and/or the parametric assumptions.

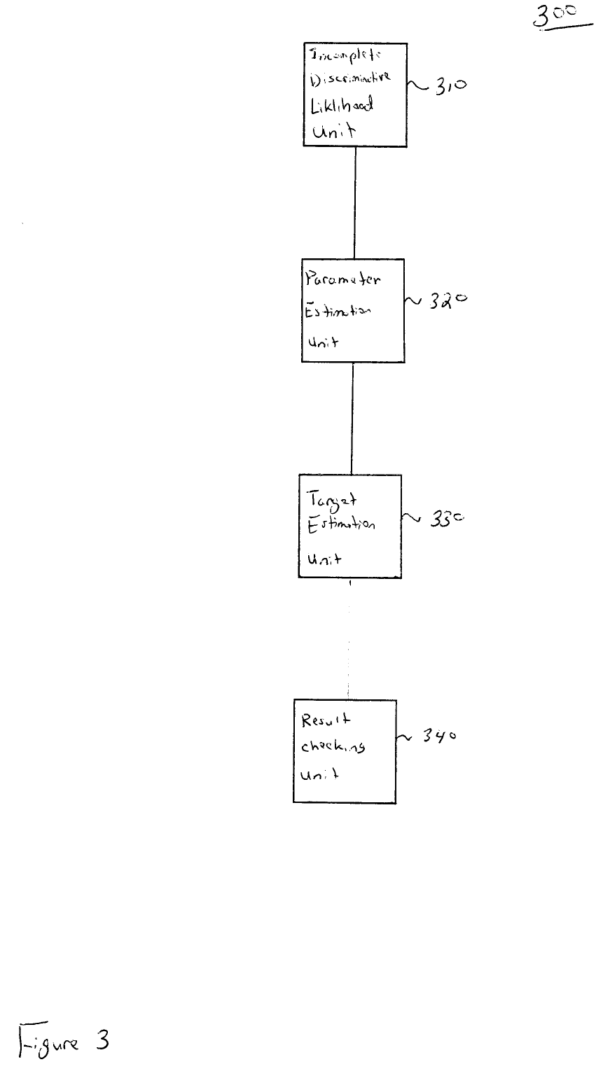

FIG. 3 illustrates a prediction system 300 in accordance with an exemplary embodiment of the present invention. The prediction system 300 includes an incomplete discriminative likelihood unit 310, a parameter estimation unit 320, a target estimation unit 330 and a result checking unit 340. The parameter estimation unit 320 estimates a parameter that corresponds to a maximum incomplete discriminative likelihood of the domain knowledge. The target estimation unit 330 estimates the target variable using an estimate of the maximum incomplete discriminative likelihood of the domain knowledge (based on the parameters estimated by the parameter estimation unit 320).

FIG. 4 illustrates a typical hardware configuration of an information handling/computer system in accordance with the invention and which preferably has at least one processor or central processing unit (CPU) 411.

The CPUs 411 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communication adapter 434 for connecting an information handling system to a data processing network, the Internet, an Intranet, a personal area network (PAN), etc., and a display adapter 436 for connecting the bus 412 to a display device 1438 and/or printer 439 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 411 and hardware above, to perform the method of the invention.

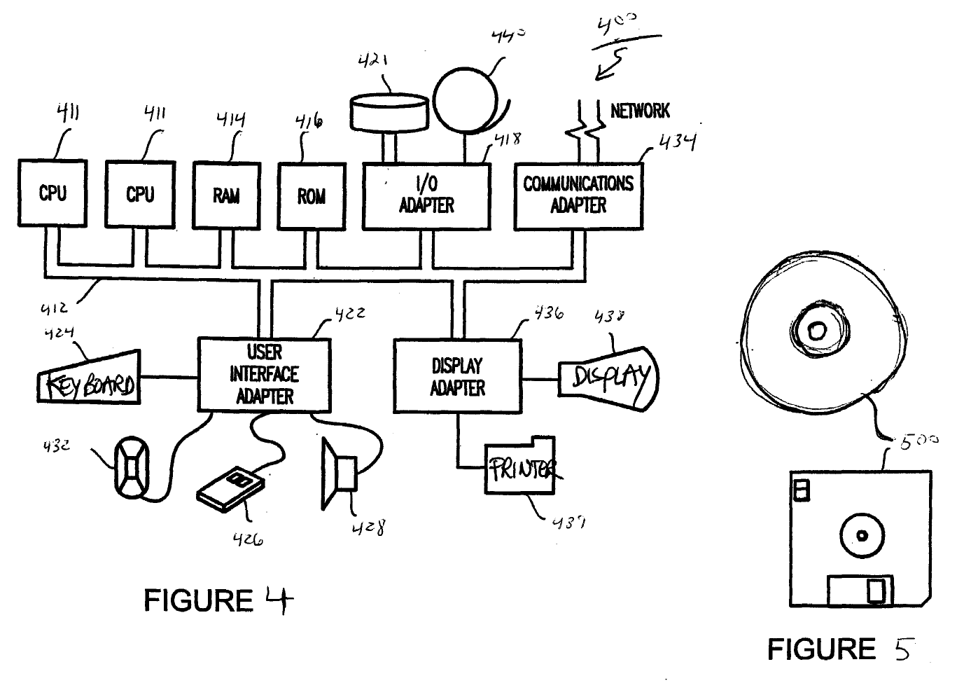

This signal-bearing media may include, for example, a RAM contained within the CPU 411, as represented by the fast-access storage for example. Alternatively, the instructions may be contained in another signal-bearing media, such as a magnetic data storage diskette 500 (e.g., see FIG. 5), directly or indirectly accessible by the CPU 411. Whether contained in the diskette 500, the computer/CPU 411, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

Thus, the method and system of the present invention formalizes a maximum likelihood estimation problem of an unsupervised (unobserved) multi-view learning setting where the target is unobserved, but two independent parametric models can be formulated. In the case of Gaussian noise, the parameter estimation task can be reduced to a single linear regression problem. Thus, for the specific setting, the unsupervised multi-view problem can be solved via a simple supervised learning approach.

Accordingly, the method and system of the present invention can be applied to problems that model a numeric quantity that is never observed and has two different, statistically independent, ways of modeling the unobserved response.

While the invention has been described in terms of several exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

What is claimed is:

1. A method of predicting an unobserved target variable, comprising:
building a graphical predictive model from domain knowledge, which takes advantage of conditional independence to facilitate inference about the unobserved target variable, given observations on other variables in the graphical predictive model from a plurality of information sources.

2. The method in accordance with claim 1, wherein said building a predictive model comprises:
estimating a parameter that corresponds to a maximum incomplete discriminative likelihood of the model which formalized domain knowledge; and
estimating the target variable using the parameters maximizing the incomplete discriminative likelihood of the graphical model which formalizes the domain knowledge.

3. The method in accordance with claim 2, wherein said building a predictive model further comprises checking a result obtained from said obtaining the target variable.

4. The method in accordance with claim 1, wherein said building a predictive model comprises:
estimating the target variable using the parameters maximizing the incomplete discriminative likelihood of the graphical model which formalizes the domain knowledge.

5. The method in accordance with claim 1, wherein said plurality of information sources comprises customer firmographics.

6. The method in accordance with claim 1, wherein said plurality of information sources comprises a company's internal databases.

7. The method in accordance with claim 1, wherein said target variable comprises a customer wallet.

8. The method in accordance with claim 1, wherein said plurality of information sources comprises customer firmographics and a company's internal database.

9. A system for predicting an unobserved target variable, comprising:
a prediction unit that builds a predictive model from domain knowledge, which provides information about the unobserved target variable.

10. The system in accordance with claim 9, wherein said prediction unit comprises:
an estimating unit that estimates a parameter that corresponds to a maximum incomplete discriminative likelihood of the graphical predictive model based on domain knowledge; and
a target estimating unit that estimates the target variable using a maximum incomplete discriminative likelihood solution of the graphical predictive model based on domain knowledge.

11. A system for predicting a target variable, comprising:
means for estimating a parameter that corresponds to a maximum incomplete discriminative likelihood of the graphical predictive model based on domain knowledge; and
means for estimating the target variable using an maximum incomplete discriminative likelihood solution of the graphical predictive model based on domain knowledge.

12. A computer-readable medium tangibly embodying a program of computer-readable instructions executable by a digital processing apparatus to perform the method of predicting a target variable in accordance with claim 1.

13. A method of deploying computer infrastructure, comprising integrating computer-readable code in a computing system, wherein the computer readable code in combination with the computing system is capable of performing the method of predicting a target variable in accordance with claim 1
